(19) United States
(12) Patent Application Publication
(10) Pub. No.: US 2023/0360350 A1
(43) Pub. Date: Nov. 9, 2023

(54) SYSTEMS AND METHODS FOR SCALING USING ESTIMATED FACIAL FEATURES

(71) Applicant: Ditto Technologies, Inc., Oakland, CA (US)

(72) Inventors: Amruta Rajendra Kulkarni, Fremont, CA (US); Tenzile Berkin Cilingiroglu, Fremont, CA (US)

(21) Appl. No.: 18/311,678

(22) Filed: May 3, 2023

Related U.S. Application Data
(60) Provisional application No. 63/337,983, filed on May 3, 2022.

(51) Int. Cl. G06T 19/20; G06T 17/00; G06T 7/60; G02C 7/02

(52) U.S. Cl. CPC G06T 19/20; G06T 17/00; G06T 7/60; G02C 7/027; G06T 2219/2016; G06T 2207/30201; G06T 2207/20081; G06T 2219/2004

(57) ABSTRACT

A system and method for scaling a user's head based on estimated facial features are disclosed. In an example, a system includes a processor configured to obtain a set of images of a user's head; generate a model of the user's head based on the set of images; determine a scaling ratio based on the model of the user's head and estimated facial features; and apply the scaling ratio to the model of the user's head to obtain a scaled user's head model; and a memory coupled to the processor and configured to provide the processor with instructions.

### CROSS-REFERENCE TO RELATED APPLICATION(S)

This application claims priority to U.S. Provisional Patent Application No. 63/337,983, filed May 3, 2022 and entitled “USING ESTIMATED FACIAL FEATURES TO DETERMINE SCALING OF A MODEL OF A USER'S HEAD,” the entire disclosure of which is hereby incorporated by reference in its entirety.

### FIELD

The described embodiments relate generally to generating a scaled model of a user. More particularly, the present embodiments relate to generating a scaled model of a user based on estimated facial features of the user, which scaled model can be used in a virtual try-on of a product.

### BACKGROUND

A person seeking to buy glasses usually has to go in person to an optometrist in order to obtain measurements of the person's head, which are then used to purchase glasses frames. Further, the person has traditionally gone in person to an optometrist or an eyewear store to try on several glasses frames to assess their fit. Typically, this requires a few hours of browsing through several rows of glasses frames and trying on many pairs of glasses frames, most of the time without prior knowledge of whether a particular glasses frame is suited to the person.

Allowing people to virtually obtain measurements of their facial features and try on glasses frames would greatly improve the efficiency of selecting spectacle frames. However, it would be desirable for the size of the glasses frames in the virtual try-on experience to be accurate, in order to better approximate the try-on experience the person would have in the real world. Further, it would be desirable for the size of the glasses frame to be fit to the person's face based on the measurements of the person's facial features.

### SUMMARY

According to some aspects of the present disclosure, a system includes a processor, and a memory coupled to the processor, the memory configured to provide the processor with instructions. The processor is configured to, when accessing the instructions, obtain a set of images of a user's head, generate a 3D model of the user's head based on the set of images, determine a scaling ratio based on the model of the user's head and estimated facial features, and apply the scaling ratio to the model of the user's head to obtain a scaled user's head model.

In some examples, the estimated facial features can include historical facial features. In some examples, determining the scaling ratio can include determining a measured facial feature from an image of the set of images, updating the model of the user's head based on the measured facial feature, and determining the scaling information based on the measured facial feature and at least a portion of the estimated facial features.

In some examples, determining the scaling ratio can include determining a head width classification corresponding to the user's head using a machine learning model based on the set of images, obtaining a set of proportions corresponding to the head width classification, determining a measured facial feature from the model of the user's head, and determining the scaling ratio based on the measured facial feature and the estimated facial features. In some examples, the estimated facial features can include the set of proportions.

In some examples, the processor can be further configured to position a glasses frame model on the scaled user's head model and determine a set of facial measurements associated with the user's head based on stored measurement information associated with the glasses frame model and the position of the glasses frame model on the scaled user's head model.

In some examples, the processor can be further configured to determine a confidence level corresponding to a facial measurement of the set of facial measurements. In some examples, the processor can be further configured to compare the set of facial measurements to stored dimensions of a set of glasses frames and output a recommended glasses frame at a user interface based at least in part on the comparison.

In some examples, the processor can be further configured to input the set of facial measurements into a machine learning model to obtain a set of recommended glasses frames and output the set of recommended glasses frames at a user interface.

According to some examples, a method for generating a three-dimensional (3D) model can include receiving a set of images of an object, generating an initial model of the object based on the set of images, determining a first measurement of a first feature of the object, classifying the object with a measurement classification, the measurement classification being associated with an estimated measurement of the first feature, determining a scaling ratio for the initial model based on the first measurement and the estimated measurement, and scaling the initial model to generate a scaled model based on the scaling ratio.

In some examples, the object can be a user's head, and the first feature can include a face width. In some examples, the measurement classification can be selected from a list including narrow, medium, and wide.

In some examples, the method can further include positioning a 3D model on the scaled model and generating measurements of the object based on the position of the 3D model on the scaled model and a comparison of the 3D model with the scaled model. In some examples, the 3D model can be associated with real-world dimensions.

In some examples, the method can further include determining measurements of the object based on the scaled model. In some examples, the method can further include determining a confidence level corresponding to each measurement of the measurements.

In some examples, the method can further include receiving a second set of images and analyzing the second set of images with a machine learning model. In some examples, each image of the second set of images can include a learning object including a learning feature associated with a second measurement and a respective measurement classification. In some examples, the machine learning model can associate each respective measurement classification of a set of measurement classifications with a respective second measurement. In some examples, the measurement classification is selected from the set of measurement classification to classify the object.

According to some examples, a computer program product embodied in a non-transitory computer readable storage medium includes computer instructions for receiving a set of images of a user's head; generating an initial three-dimensional (3D) model of the user's head based on the set of images; analyzing the set of images to detect a facial feature on the user's head; comparing the detected facial feature with an estimated facial feature to determine a scaling ratio, the estimated facial feature including at least one of an iris diameter, an ear junction distance, or a temple distance; and scaling the initial 3D model to generate a scaled 3D model based on the scaling ratio.

In some examples, the estimated facial feature can include an average measurement of a facial feature in a population, and the computer instructions can further include determining the estimated facial feature. In some examples, the estimated facial feature can include the iris diameter; and the iris diameter can be from 11 mm to 13 mm.

In some examples, the computer instructions can further include positioning a 3D model of a glasses frame on the scaled 3D model and determining facial measurements of the user based on measurements associated with the 3D model of the glasses frame and the position of the glasses frame on the scaled 3D model.

In some examples, the computer instructions can further include determining a head width classification of the user's head, and determining the estimated facial feature based on the head width classification of the user's head.

In some examples, the computer instructions can further include associating head width classifications of a set of head width classifications with respective estimated facial features of a set of estimated facial features using a machine learning model that can include an input of a set of images. In some examples, each image of the set of images can include a head width classification and a facial feature measurement.

### BRIEF DESCRIPTION OF THE DRAWINGS

Various embodiments of the invention are disclosed in the following detailed description and the accompanying drawings.

FIG. 1 is a flow diagram of a method of generating a scaled model of a user's head.

FIG. 2 is a block diagram of a system for generating a scaled model of a user's head.

FIG. 3 is a block diagram of a server for generating a scaled model of a user's head.

FIG. 4 illustrates a set of images of a user's head.

FIG. 5 illustrates reference points on a user's head.

FIG. 6 is a flow diagram of a method of generating a scaled model of a user's head.

FIG. 7 is a flow diagram of a method of generating a scaled model of an object.

### DETAILED DESCRIPTION

The present exemplary systems and methods can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the systems and methods may take, may be referred to as techniques. In general, the order of the steps of disclosed processes may be altered within the scope of the claimed invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the systems and methods is provided below along with accompanying figures that illustrate the principles. The present system is described in connection with such embodiments, is not limited to any embodiment. Rather, the scope is limited only by the claims and encompasses numerous alternatives, modifications and equivalents. Numerous specific details are set forth in the following description in order to provide a thorough understanding of the present exemplary systems and methods. These details are provided for the purpose of example and the present systems and methods may be practiced according to the claims without some or all of these specific details. For clarity, technical material that is known in the technical fields related to the exemplary systems and methods has not been described in detail so that the present invention is not unnecessarily obscured.

A model of a user's head can be generated and scaled based on a two-dimensional (2D) image that shows the user holding a reference object (e.g., a standard-sized card, such as a credit card) over their face. This model can be used to collect measurements of the user's head, the head measurements can be used to provide product recommendations to the user, and products can be overlaid and displayed on the model of the user's head. However, generating the model of the user's head based on a 2D image can be insufficiently accurate. For example, as the 2D image holds 2D information, the actual size and orientation of objects in the 2D image cannot be ascertained or can be ascertained with error. The reference object can appear to have a different size in the 2D image depending on its tilt or orientation such that comparing the apparent size of the reference object in the 2D image with the apparent size of the user's head does not provide enough accuracy to correctly scale the model of the user's head.

In more detail, the approach of scaling a 3D model of a user's head using a 2D image including a user's head and a reference object (e.g., a standard sized card, such as a credit card or a library card) can include obtaining an image of the user's head that shows the reference object. Locations of certain features of the reference object, such as two or more corners of a standard sized card, can be detected. 2D points of features of the user's head can be detected and used to determine scaling. The features can include, for example, the user's external eye corners. The known physical dimensions of the reference object, such as a height and width of the standard sized card, can then be used along with the detected locations of the features on the user's head, in order to calculate a scale coefficient. However, it may not be convenient for a user to obtain a suitable reference object to appear with the user's head in the image.

Some of the head measurements that can be used for recommending products (e.g., glasses frames, prescription glasses, and the like) to a user, such as pupillary distance (PD), segment height, and face width, need to be determined with greater accuracy than can be provided by analyzing the 2D image including the reference object. The pupillary distance is a measurement of a distance between centers of a user's pupils. The segment height is a measurement from a bottom of a lens of a pair of glasses to a center of a pupil of a user. The face width is a measurement based on a distance between opposite ear junctions or temples of a user. In order to accurately measure the segment height for a pair of glasses relative to a user's face, the glasses must be accurately positioned on the user's face in a three-dimensional (3D) space, which is difficult using a 2D image-based approach. Similarly, in order to accurately measure the face width of a user, accurate orientation of the user's head must be determined, which is difficult using a 2D image-based approach. Accordingly, a technique for accurately determining measurements of a user's head, and that eliminates a requirement for a reference object is desired.

The following disclosure relates to systems and methods that use estimated facial features to determine scaling of a model of a user's head. The systems and methods can generate a 3D model of a user's head and scale that model based on the estimated facial features. The 3D model can then be used to determine measurements of the user's head, to recommend products to the user, to present products to the user (e.g., through virtual try-ons and the like), and the like.

Various examples described herein eliminate the use of a reference object in input images that are used to generate and scale a model of a user's head. Instead, estimated facial features of a user are used to determine appropriate scaling of a 3D model of the user's head. In some examples, the 3D model of the user's head is generated based on estimated dimensions of points or features on the user's head. By avoiding the use of a reference object, the ease with which a user can submit images to obtain head measurements, suitable recommendations of products that correspond to the user's head measurements, and 3D previews of products on the user, is improved.

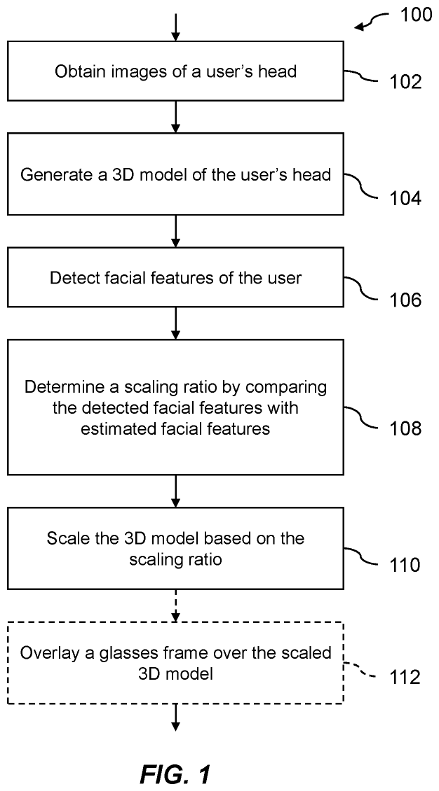

FIG. 1 is a flow chart illustrating a method for generating a scaled model of a user's head based on estimated facial features. At step 102, images of the user's head are obtained. In some examples, the images include at least one frontal image of the user's head. The images can include a set of images (e.g., a video), such as a series of images that capture the user performing a head turn. In some examples, the user can be prompted to perform a specific head turn, or to move their head to certain positions in order to obtain the set of images. In some examples, the set of images can include a minimum number of images of the user's head in a minimum number of positions used to generate a 3D model of the user's head.

At step 104, a 3D model of the user's head is generated. The 3D model can be generated based on the set of images of the user's head. The 3D model can be a mesh model of the user's head. The 3D model may include one or more of the following: images/video frames of the user's head, reference points on the user's head, or a set of rotation/translation matrices. In some examples, the 3D model is limited to reference points associated with the user's head. An initial 3D model can be generated based on a subset of the set of images of the user's head. The initial 3D model can then be adjusted to an adjusted 3D model using an iterative algorithm incorporating additional information from the set of images of the user's head.

Each of the images of the set of images can be used together to generate the 3D model of the user's head. For example, each of the images of the set of images can be analyzed to determine a pose of the user. The pose of the user's head in each image can include a rotation and/or a translation of the user's head in the respective image. The pose information for each image can be referred to as extrinsic information. Reference points can be determined from the images of the set of images and mapped to points on the 3D model of the user's head. Intrinsic information can also be used to aid in generating the 3D model. The intrinsic information can include a set of parameters associated with a camera used to record the set of images of the user's head. For example, a parameter associated with a camera can include a focal length of the camera. The intrinsic information can be calculated by correlating points detected on the user's head while generating the 3D model. The intrinsic information can aid in providing depth information and measurement information used to generate the 3D model.

At step 106, facial features of the user are detected. The facial features can be detected by analyzing the set of images of the user's head and can be marked or otherwise recorded on the 3D model. The facial features can include any facial features that can be used to scale the 3D model to real-world dimensions. The facial features can include positions of facial features, sizes of facial features, and the like. In some examples, the facial features can include positions and/or sizes of the user's irises, which can be marked by an iris contour applied to the images and/or the 3D model. In some examples, the facial features can include positions of the user's temples, ear junctions, pupils, eyebrows, eye corners, a nose point, a nose bridge, cheekbones, and the like. In examples in which the facial features include positions of the user's temples or ear junctions, the facial features can include a face width of the user's face. In examples in which the facial features include positions of the user's pupils, the facial features can include a pupil distance of the user's face. As will be discussed in detail below, diameters of the user's irises, the user's face width, and/or the user's pupillary distance can be used to scale the 3D model to real-world dimensions.

In step 108, a scaling ratio is determined by comparing the detected facial features with estimated facial features. The estimated facial features can include average measurements of facial features, which can be determined for various populations. For example, the estimated facial features can include average measurements of facial features based on race, facial descriptions, age, height, weight, region, or any other populations or groupings. The estimated facial features can include empirical or historical measurements of facial features of the user. For example, a historical measurement of a user's pupillary distance, facial width, iris diameter, or the like can be used. In step 110, the 3D model is scaled based on the scaling ratio. As long as the distance between any points on the 3D model of the user's head in real-world dimensions is determined or known, the scaling ratio can be determined and applied to the 3D model of the user's head to generate the scaled 3D model of the user's head based on the known distance.

In some examples, the estimated facial features can include an iris diameter. An average measurement of a diameter of a human iris is from about 11 mm to about 13 mm. An image of the set of images of the user's head (e.g., a frontal image) can be analyzed to detect a position of the user's iris, and an iris contour can be marked. This frontal image and any additional images of the user's head can be combined in order to generate a 3D model of the user's head, and the iris contour can be marked on the generated 3D model. The detected diameter of the user's iris can be compared to the average diameter of a human iris, and the scaling ratio can be determined based on this comparison. The generated 3D model of the user's head can then be scaled such that the diameter of the iris contour matches in the scaled 3D model matches the average diameter of a human iris. Thus, in some examples, the scaled 3D model of the user's head can be generated based on a comparison of a detected iris diameter with an average human iris diameter. The scaled 3D model of the user's head is scaled to match real-world dimensions of the user's head.

In some embodiments, the estimated facial features can include proportions of facial features. The proportions of facial features can be associated with head width classifications. In some examples, a database can include associations between head width classifications and proportions of facial features. In some examples, a machine learning model can be trained on user images labeled with corresponding head width classifications (e.g., narrow, medium, wide, or the like). In some examples, other head classifications can be associated with the proportions of facial features, such as feature size (e.g., nose size, lip size, eye size, face shape, or the like).

The machine learning model or another algorithm can determine a relation between proportions of users' facial features and their corresponding head classifications, such as the head width classifications. The proportions of facial features can include a distance between the user's eye, a ratio of a face length to a face width, a distance between the user's brows and lips, a width of the user's jawline, a width of the user's forehead, and the like.

The proportions of facial features can be calculated in a 2D space or a 3D space, depending on the type of data that is available for each user in the training data. In examples in which the available dataset of a user in the training data includes only a frontal image of the user's head, the proportions of facial features can be calculated in a 2D space after determining facial features (e.g., eyes, eyebrows, a face contour, and the like) in the frontal image. In examples in which the available dataset of a user in the training data includes a set of images of the user, such as a set of head turn images, the proportions can be calculated in a 3D space after a 3D model of the user's head is generated. The 3D model can be generated and scaled based on the set of images, as described above. As such, in both examples in which a single frontal image of a user's head, or a set of images of a user's head is included in training data for a machine learning model, the trained machine learning model will output proportions of facial features corresponding with a head width classification, or other head classifications.

Each of the head classifications and the head width classifications is associated with a corresponding set of proportions of facial features. The scaling ratio used to scale the generated 3D model of the user's head can be determined by dividing a detected user facial feature proportion (e.g., a distance between the user's eyes) by the corresponding facial feature proportion associated with the user's head classification. The generated 3D model of the user's head can then be scaled using the scaling ratio such that the facial proportion of the scaled 3D model matches the facial feature proportion associated with the user's head classification. Thus, in some examples, the scaled 3D model of the user's head can be generated based on a comparison of a detected facial feature proportion with a facial feature proportion associated with a user's head classification. The scaled 3D model of the user's head is scaled to match real-world dimensions of the user's head.

In some examples, the estimated facial features can include historical measurements of features of the user's head. For example, the estimated facial features can include a previously measured pupillary distance of the user. In such examples, the scaling ratio can be determined by dividing a detected pupillary distance of the user with the previously measured pupillary distance of the user. The generated 3D model of the user's head can then be scaled using the scaling ratio such that the pupillary distance of the scaled 3D model matches the previously measured pupillary distance of the user. Thus, in some examples, the scaled 3D model of the user's head can be generated based on a comparison of a detected facial feature with a facial feature of the user that was previously measured. The scaled 3D model of the user's head is scaled to match real-world dimensions of the user's head.

In some examples, the scaled 3D model of the user's head can be used to derive measurements of the user's head. These head measurements can be used for any purposes. The head measurements can include a single pupillary distance measurement, a dual pupillary distance measurement, a face width, or any other desired measurement. In some examples, the measurements of the user's head can be used for ordering glasses frames that are a fit to the user's head.

In some examples, at least some of the measurements of the user's head that are derived from the scaled 3D model of the user's head are assigned a corresponding confidence level or another classification of accuracy. For example, a confidence level can be assigned to a single pupillary distance measurement, a dual pupillary distance measurement, a face width measurement, or the like. In some examples, the confidence level estimation can be based on a machine learning approach, which can assign a confidence level or an accurate/inaccurate label to a facial measurement that is derived from the scaled 3D model of the user's head. This machine learning approach can use different features in order to make this estimation. Examples of features that can be used by the machine learning approach for the confidence level estimation include the pose of the user's head in the frontal image, and confidence levels associated with the placement of facial features on the generated 3D model of the user's face.

In optional step 112, a glasses frame is overlaid over the scaled 3D model of the user's head. In some examples, the measurements of the user's head derived from the scaled 3D model of the user's head can be used to recommend products to the user. For example, the derived head measurements (e.g., single pupillary distance, dual pupillary distance, face width, nose bridge width, and the like) can be compared against the real-life dimensions of glasses frames in a database. Glasses frames with dimensions that best fit or correspond to the user's derived head measurements can be output, at a user interface, as recommended products for the user to try on and/or purchase. In some examples, the recommendations of products (e.g., glasses frames) can be generated using machine learning. For example, the user's derived head measurements can be input into a machine learning model for providing glasses frame recommendations and the machine learning model can output glasses frame recommendations to the user based on the user's head measurements. In some examples, the glasses frame recommendations output by the machine learning model can be based on the user's head measurements, as well as glasses frames purchased by users having similar head measurements.

Any recommended glasses frames provided to the users can be a subset of a set of available glasses frames. The user can select frames to view from the subset of recommended glasses frames, or the set of available glasses frames. When a user selects a glasses frame, the glasses frame can be output and overlaid over the scaled 3D model of the user's head, for a virtual try-on of the selected glasses frame.

In some examples, the selected glasses frame can be altered to fit the user. For example, the scaling ratio or the user's head measurements can be used to scale a 3D model of the selected glasses frame when the user is performing a virtual try-on of the selected glasses frame. As a result, the user can see a correctly sized version of the selected glasses frame overlaid on the scaled 3D model of the user's head in the virtual try-on.

In some examples, measurements of the user's head can be calculated by placing a 3D model of a glasses frame (e.g., a selected glasses frame) on the scaled 3D model of the user's head. In other words, the measurements of the user's head can be calculated by leveraging a fitting approach where a 3D model of a glasses frame is placed on the scaled 3D model user's head. A database of digital glasses frames with accurate real-world dimensions can be maintained and a glasses frame from the database can be fitted on the scaled 3D model of the user's head. After the placement of the 3D model of the glasses frame onto the scaled 3D model of the user's head, measurements of the user's head can be calculated based on the placement of the 3D model of the glasses frame on the scaled 3D model of the user's head. The measurements can include a segment height, a temple length, a single pupillary distance, a dual pupillary distance, a face width, a nose bridge width, or the like.

In some examples, locations of the user's pupils on the scaled 3D model can be used to measure the single pupillary distance, the dual pupillary distance, or the like. In some examples, the locations of the user's pupils on the scaled 3D model can be determined using the detection and un-projection of the iris center key points. The segment height is a vertical measurement from the bottom of the lens of the glasses frame to the center of the user's pupil. The temple length is a measurement from the front of the lens to the point where the temple sits on the user's ear juncture. The nose bridge width is the width of the user's nose bridge where the glasses frame is placed. All these measurements can be calculated once the 3D model of the glasses frame is placed on the scaled 3D model of the user's head, since the scaled 3D model of the user's head has already been accurately scaled.

Although the method 100 has been referred to as being used to generate a scaled model of a user's head, the method 100 can be used to generate a scaled model of any object. For example, the method 100 can be used to generate a scaled model of a user's body, of any inanimate object, or of anything desired. Estimated features can depend on specific objects that are desired to be scaled. As an example, height can be used to generate a scaled model of a user's body. Any known or estimated measurements can be used to generate models of objects.

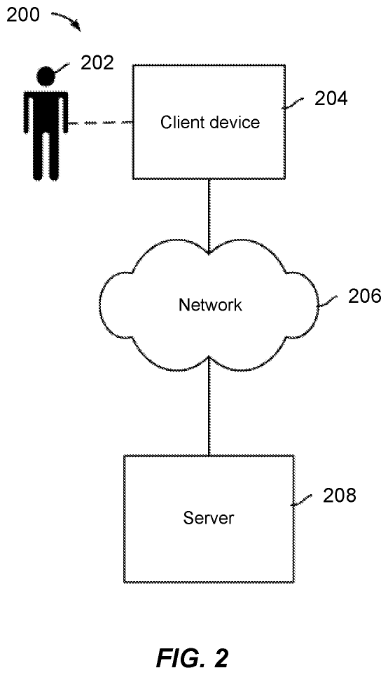

FIG. 2 is a block diagram of a system 200 for generating a scaled model of a user's head based on estimated facial features (e.g., for implementing the method 100 of FIG. 1). For simplicity, the system 200 is referred to as being for generating a scaled model. The data generated by the system 200 can be used in a variety of other applications including using the measurement data and the scaled models for the fitting of glasses frames to a user. In some examples, the system 200 can also be used to position a glasses frame relative to the scaled model of the user's head.

The system 200 can include a client device 204, a network 206, and a server 208. The client device 204 can be coupled to the server 208 via the network 206. The network 206 can include high speed data networks and/or telecommunications networks. A user 202 may interact with the client device 204 to generate a scaled model of the user. The scaled model of the user can be used to determine various head measurements of the user. The scaled model can be used to “try on” a product, e.g., providing user images of the user's body via the client device 204 and viewing a virtual fitting of the product to the user's body according to the techniques further described herein.

The client device 204 is configured to provide a user interface for the user 202. For example, the client device 204 may receive input such as images of the user 202 captured by a camera of the client device 204 or observe user interaction by the user 202 with the client device 204. Based on at least some of the information collected by the client device 204, a scaled 3D model of the user can be generated. In some examples, a simulation of placing a product on the user's body (e.g., placing a glasses frame on the user's head) can be output to the user 202.

In some examples, the client device 204 includes an input component, such as a camera, a depth sensor, a LIDAR sensor, another sensor, or a combination of multiple sensors. In examples in which the client device 204 includes a camera, the camera can be configured to observe and/or capture images of the user 202 from which facial features (also referred to as physical characteristics) can be determined. The user 202 may be instructed to operate the camera or pose for the camera as further described herein. The information collected by the input components may be used and/or stored for generating the scaled 3D model.

The server 208 is configured to determine facial features from input images, determine a correlation between the facial features and estimated facial features of the user, and output a scaled 3D model of the user that is scaled to real-world dimensions. The server 208 can be remote from the client device 204 and accessible via the network 206, such as the Internet. Various functionalities of the system 200 and the method 100 can be embodied in either the client device 204 or the server 208. For example, functionalities traditionally associated with the server 208 may be performed not only by the server 208 but also/alternatively by the client device 204 and vice versa. The output can be provided to the user 202 with very little (if any) delay after the user 202 provides input images. As such, the user 202 can experience a live fitting of a product. Virtual fitting of products to a user's face has many applications, such as virtually trying-on facial accessories such as eyewear, makeup, jewelry, etc. For simplicity, the examples herein chiefly describe live fitting of glasses frames to a user's face/head. However, this is not intended to be limiting and the techniques may be applied to trying on other types of accessories and may be applied to video fittings (e.g., may have some delay).

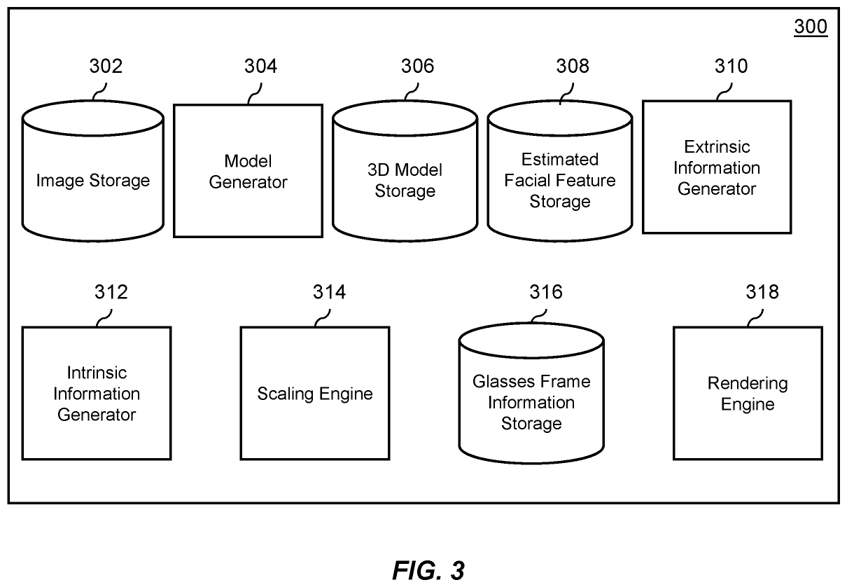

FIG. 3 is a block diagram of a server 300 for generating a scaled model of a user's head. In some examples, the server 300 can be used for virtual fitting of glasses to the scaled model of the user's head, and for obtaining measurements of the user's head. In some examples, the server 300 can be used to generate scaled models of any objects. In some examples, the server 208 of the system 200 of FIG. 2 is implemented using the example of FIG. 3. The server 300 can include an image storage 302, a model generator 304, a 3D model storage 306, an estimated feature storage 308, an extrinsic information generator 310, an intrinsic information generator 312, a scaling engine 314, a glasses frame information storage 316, a rendering engine 318, and a fitting engine 320. The server 300 can be implemented with additional, different, and/or fewer components than those shown in the example of FIG. 3. Each of the image storage 302, the 3D model storage 306, the estimated feature storage 308, and the glasses frame information storage 316 can be implemented using one or more types of storage media. Each of the model generator 304, the extrinsic information generator 310, the intrinsic information generator 312, the scaling engine 314, the rendering engine 318, and the fitting engine 320 can be implemented using hardware and/or software. The various components of the server 300 can be included and/or implemented through the server 208 and/or the client device 204 in the system 200 of FIG. 2.

The image storage 302 can be configured to store sets of images. In some examples, each set of images is associated with a recorded video or a series of snapshots of various orientations of a user's head (e.g., a user's face). In some examples, each set of images is stored with data associated with the whole set, or individual images of the set. The image storage 302 can be configured to store the set of images referenced in step 102 of the method 100 of FIG. 1.

The model generator 304 can be configured to determine a mathematical 3D model of the user's head associated with each set of images. The model generator 304 can generate an initial 3D model, such as the generated 3D model of step 104 of the method 100 of FIG. 1 and can scale and update the generated 3D model to generate a scaled 3D model, such as the scaled 3D model of step 110 of the method 100 of FIG. 1.

The model generator 304 can detect facial features of the user's head and determine measurements of facial features of the user's head, which can be associated with the generated 3D model of the user's head and stored in the model generator 304. For example, the model generator 304 can detect edges of a user's irises and determine a distance between opposite edges of the user's irises, referred to as an iris distance or an iris diameter. The model generator 304 can detect a user's ear junctions and determine a distance between opposite ear junctions of the user, referred to as an ear junction distance or a face width. The model generator 304 can detect a user's temples and determine a distance between opposite temples of the user, referred to as a temple distance or a face width. The iris distance, the ear junction distance, and the temple distance can be measure using any suitable units, such as pixels or the like. As will be discussed in detail below, the iris distance, the ear junction distance, the temple distance, combinations thereof, or any other suitable distances or measurements can be used to scale the 3D model of the user's head. The model generator 304 can be configured to store the detected facial features (e.g., as reference points), and the determined measurements of the user's head in the 3D model storage 306.

The mathematical 3D model of the user's head (e.g., the mathematical model of the user's head in a 3D space) may be set at an origin. In some examples, the 3D model of the user's head includes a set of points in the 3D space that define a set of reference points associated with (e.g., the locations of) features on the user's head (e.g., facial features), which are detected from the associated set of images. Examples of the reference points include endpoints of the user's eyes, endpoints of the user's eyebrows, a bridge of the user's nose, juncture points of the user's ears, a tip of the user's nose, and the like.

In some examples, the mathematical 3D model determined for the user's head is referred to as an M matrix. The M matrix can be determined based on the set of reference points associated with the facial features on the user's head, which are determined from the associated set of images. In some examples, the model generator 304 can be configured to store the M matrix determined for a set of images along with the set of images in the image storage 302. In some examples, the model generator 304 can be configured to store the 3D model of the user's head in the 3D model storage 306. Thus, the model generator 304 can perform step 106 of the method 100 of FIG. 1.

The estimated facial feature storage 308 can be configured to estimated facial features. In some examples, the estimated facial features include average feature sizes in a population of users. For example, the average diameter of a human's iris is in a range from about 11 mm to about 13 mm, and the average diameter of the human iris can be stored as an estimated facial feature in the estimated facial feature storage 308. In some examples, the estimated facial features can be associated with a characteristic classification. For example, a user can characterize their head as being narrow, medium, or wide, and average face widths for each characteristic classification can be stored as estimated facial features in the estimated facial feature storage 308. The estimated facial features stored in the estimated facial feature storage 308 can be used in step 108 of the method 100 of FIG. 1.

The extrinsic information generator 310 can be configured to determine a set of extrinsic information for each image of at least a subset of a set of images. The set of images can be stored in the image storage 302. In some examples, a set of extrinsic information corresponding to an image of a set of images describes one or more of an orientation and a translation of a 3D model of the user's head determined for the set of images, which result in the correct appearance of the user's head in the respective image. In some examples, the set of extrinsic information determined for an image of a set of images associated with a user's head is referred to as an (R, t) pair where R is a rotation matrix and t is a translation vector corresponding to the respective image. The (R, t) pair corresponding to an image of a set of images can transform the M matrix (representing the 3D model of the user's head) corresponding to that set of images (R×M+t) into the appropriate orientation and translation of the user's head that is shown in the image associated with that (R, t) pair. In some examples, the extrinsic information generator 310 can be configured to store the (R, t) pair determined for each image of at least a subset of a set of images with the set of images in the image storage 302.

The intrinsic information generator 312 can be configured to generate a set of intrinsic information for a camera associated with recording a set of images. The camera can be a camera that was used to record a set of images stored in the image storage 302. In some examples, a set of intrinsic information corresponding to a camera describes a set of parameters associated with the camera. For example, a parameter associated with a camera can include a focal length. In some examples, the set of intrinsic information associated with a camera can be found by correlating points on a scaling reference object between different images of the user with the scaling reference object in the images, and calculating the set of intrinsic information that represents the camera's intrinsic parameters using a camera calibration technique. In some examples, the set of intrinsic information associated with a camera is found by using a technique of auto-calibration, which does not require a scaling reference. In some examples, the set of intrinsic information associated with a camera can be referred to as an I matrix. In some examples, the I matrix projects a version of a 3D model of a user's head transformed by an (R, t) pair corresponding to a particular image onto a 2D surface of the focal plane of the camera. In other words, I×(R×M+t) results in the projection of the 3D model, the M matrix, in the orientation and translation transformed by the (R, t) pair corresponding to an image, onto a 2D surface. The projection onto the 2D surface is the view of the user's head as seen from the camera. In some examples, the intrinsic information generator 312 can be configured to store an I matrix determined for the camera associated with a set of images with the set of images in image storage 302.

The scaling engine 314 can be configured to generate a scaled 3D model of a user's head. For example, the scaling engine 314 can retrieve a 3D model of a user's head generated by the model generator 304 based on a set of images in the image storage 302 from the 3D model storage 306. The scaling engine 314 can determine a scaling ratio for the 3D model of the user's head. For example, the scaling engine 314 can compare the detected facial features and the determined measurements of the user's head generated by the model generator 304 and stored in the 3D model storage 306 with the estimated facial features stored in the estimated facial feature storage 308 to determine the scaling ratio. The scaling engine 314 can then scale the 3D model to generate a scaled 3D model based on the scaling ratio such that the detected facial features and the determined measurements of the user's head correspond to the estimated facial features. For example, the scaling engine 314 can scale the 3D model of the user's head such that the iris distance of the scaled 3D model corresponds with an average diameter of a human iris. In some examples, the scaling engine 314 can scale the 3D model of the user's head such that the ear junction distance and/or the temple distance correspond to an average face width for a particular characteristic classification of the user (e.g., for a narrow, medium, or wide head). The scaling engine 314 can perform step 110 of the method 100 of FIG. 1.

The glasses frame information storage 316 can be configured to store information associated with various glasses frames. For example, information associated with a glasses frame can include measurements of various areas of the frame (e.g., a bridge length, a lens diameter, a temple distance, or the like), renderings of the glasses frame corresponding to various (R, t) pairs, a mathematical representation of a 3D model of the glasses frame that can be used to render a glasses image for various (R, t) parameters, a price, an identifier, a model number, a description, a category, a type, a glasses frame material, a brand, a part number, and the like. In some examples, the 3D model of each glasses frame includes a set of 3D points that define various locations/portions of the glasses frame, including, for example, one or more of the following: a pair of bridge points and a pair of temple bend points. In some examples, information associated with a glasses frame can include a range of user head measurements for which the glasses frame has a suitable or recommended fit.

The rendering engine 318 can be configured to render a selected glasses frame to be overlaid on a scaled 3D model of a user's head. The selected glasses frame may be a glasses frame for which information is stored in the glasses frame information storage 316. The scaled 3D model can be stored in the 3D model storage 306, or the rendering engine 318 can render the selected glasses frame over an image, such as a respective image of a set of images stored in the image storage 302. In some examples, the rendering engine 318 can be configured to render a glasses frame (e.g., selected by a user) for each image of at least a subset of a set of images stored in the image storage 302. In some examples, the rendering engine 318 can be configured to transform the glasses frame by the (R, t) pair corresponding to a respective image. In some examples, the rendering engine 318 can be configured to perform occlusion on the transformed glasses frame using an occlusion body determined from the scaled 3D model of the user's head at an orientation and translation associated with the (R, t) pair. The occluded glasses frame at the orientation and translation associated with the (R, t) pair excludes certain portions hidden from view by the occlusion body at that orientation/translation. For example, the occlusion body may include a generic face 3D model, or the M matrix associated with the set of images associated with the image. The rendered glasses frame for an image can show the glasses frame at the orientation and translation corresponding to the image and can be overlaid on that image in a playback of the set of images to the user at a client device. The rendering engine 318 can perform step 112 of the method 100 of FIG. 1.

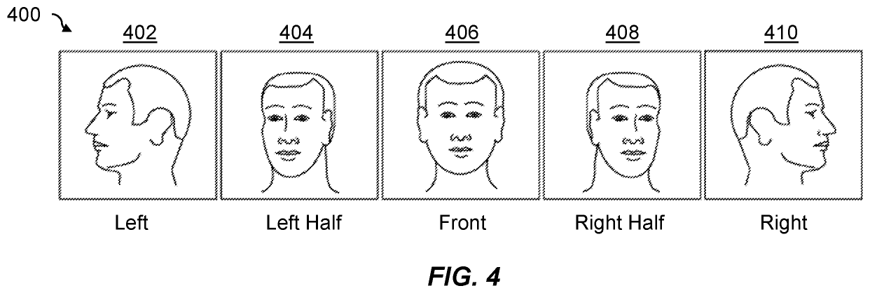

FIG. 4 illustrates a set of received images and/or video frames 400 of a user's head. The set of images 400 shows various orientations of the user's head (images 402-410). The set of images 400 can be captured by a camera that the user is in front of. The user can be instructed to turn their head as the camera captures video frames of the user's head. The user can be instructed to look left and then look right. The user can be shown a video clip, or an animation of a person turning their head and can be instructed to do the same. The number of video frames captured can vary. The camera can be instructed by a processor to capture the user's head with a continuous video or snapshots. For example, the camera can capture a series of images with a delay between each image capture. The camera can capture images of the user's head in a continuous capture mode, where the frame rate can be lower than capturing a video. The processor can be local or remote, for example on a server. The set of images 400 can be processed to remove redundant and/or otherwise undesirable images, and specific images in the set can be identified as representing different orientations of the user's head. The set of images 400 can be used to determine a 3D model of the user's head, which can be scaled, used for measurement, and used to place or fit selected glasses frames.

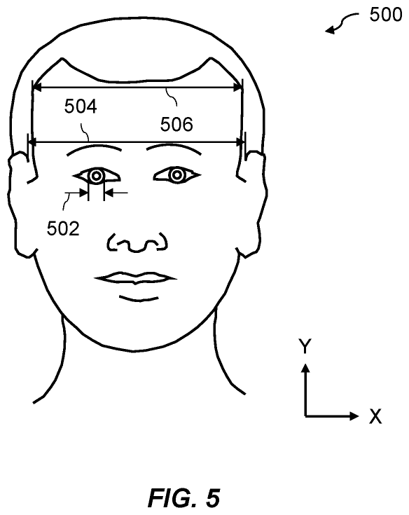

FIG. 5 illustrates detected reference points obtained from a set of images of a user's head. The reference points define the locations of various facial features and are used to scale a 3D model of the user's head. FIG. 5 shows a frontal image 500 of the user's head. Reference points can be placed at opposite sides of the user's iris such that an iris diameter 502 can be determined. Reference points can be placed at opposite ear junctions of the user such that a first facial width 504 can be determined. Reference points can be placed at opposite temples of the user such that a second facial width 506 can be determined. Any of the iris diameter 502, the first facial width 504, and/or the second facial width 506 can be used with estimated facial features in order to scale a 3D model of the user's head.

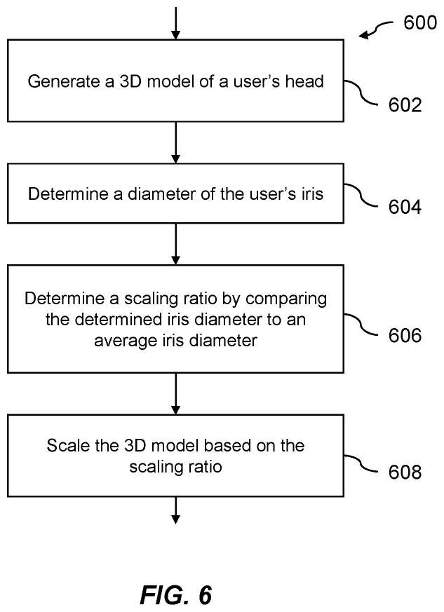

FIG. 6 illustrates a method 600 for generating a scaled 3D model of a user's head using an iris diameter. In step 602, a 3D model of a user's head is generated. In some examples, the 3D model can be unscaled, or can be scaled with arbitrary measurements, such as pixels. The 3D model can be generated based on a set of images of the user's head, such as a set of images recorded as the user performs a head turn. The set of images can include at least one frontal image of the user's head. Step 602 can be similar to, or the same as, step 102 of method 100, discussed above with respect to FIG. 1.

In step 604, a diameter of the user's iris is determined. The user's irises can be detected by analyzing the set of images of the user's head, such as the frontal image of the user's head. Boundaries of the user's irises can be marked or otherwise recorded on the 3D model (e.g., as reference points on the 3D model). An iris contour can be applied to the images of the set of images and/or the 3D model of the user's head. A diameter of each of the user's irises can be measured or determined based on the boundaries of the user's irises. In some examples, the diameters of the user's irises can be measured in pixels, although any suitable measurement units can be used. Step 604 can be similar to or the same as step 106 of method 100, discussed above with respect to FIG. 1.

In step 606, the diameter of the user's iris is compared to an average diameter of a human iris to determine a scaling ratio. An average measurement of a diameter of a human iris is from about 11 mm to about 13 mm. The average diameter of a human iris can be compared to (e.g., divided by) the determined diameter of the user's iris, thus determining the scaling ratio. Step 606 can be similar to or the same as step 108 of method 100, discussed above with respect to FIG. 1.

In step 608, the 3D model is scaled based on the scaling ratio. The 3D model can be scaled using the scaling ratio by multiplying the 3D model of step 602 by the scaling ratio. As a result, the iris diameter of the user in the scaled 3D model can correspond to or otherwise match the average human iris diameter. In some examples, the scaled 3D model can be used to present 3D models of glasses frames over the user's head in virtual try-ons or the like. In some examples, head measurements can be determined from the scaled 3D model, such as to be used in ordering prescription glasses or the like. Glasses frame-specific measurements (e.g., temple length, segment height, and the like) can be obtained by overlying models of glasses frames over the scaled 3D model and determining measurements based on the overlay. Step 608 can be similar to or the same as step 110 of method 100, discussed above with respect to FIG. 1.

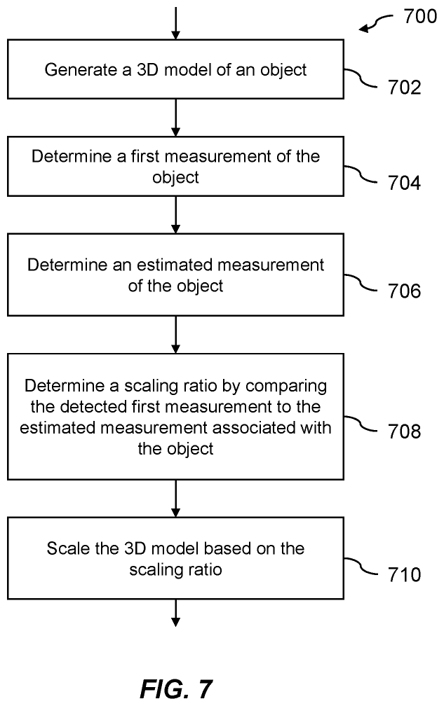

FIG. 7 illustrates a method 700 for generating a scaled 3D model of an object using a classification of the object. In step 702, a 3D model of an object is generated. The object can be a user's head, a user's body, a glasses frame, or any other suitable object. In some examples, the 3D model can be unscaled, or can be scaled with arbitrary measurements, such as pixels. The 3D model can be generated based on a set of images of the object, such as a set of images recorded as a camera circles, or otherwise moves, relative to the object. The set of images can include at least one frontal image of the object. Step 702 can be similar to or the same as step 102 of method 100, discussed above with respect to FIG. 1.

In step 704, a first measurement of the object is determined. The first measurement can be any suitable measurement, depending on the identity of the object, such as a height, a width, a length, or the like. In an example in which the object is a user's face, the first measurement can be a width of the user's face, a distance between opposite ear junctions of the user, a distance between opposite temples of the user, or the like. In an example in which the object is a user's body, the first measurement can be a height of the user, a width of the user, or the like. In an example in which the object is a glasses frame, the first measurement can be a width of the glasses frame. The first measurement can be determined by analyzing the set of images of the object. Boundaries of the object can be marked or otherwise recorded on the 3D model (e.g., as reference points on the 3D model). In some examples, the first measurement of the object can be measured in pixels, although any suitable measurement units can be used. Step 704 can be similar to or the same as step 106 of method 100, discussed above with respect to FIG. 1.

In step 706, an estimated measurement of the object is determined. The estimated measurement of the object can be determined by associating a measurement classification with the object. The measurement classification can be a general description of the object. For example, in an example in which the object is a user's face, the measurement classification can be a description of the width of the user's face, such as narrow, medium, or wide. In an example in which the object is a user's body, the measurement classification can be a description of the user's body. For example, the measurement classification can refer to the user's height, such as tall, average, or short; the user's body type, such as stocky, lanky, etc.; or the like. In an example in which the object is a glasses frame, the measurement classification can be a description of the width of the glasses frame, such as narrow, medium, or wide; a description of the height of the glasses frame, such as short, medium, or tall; or the like. A machine learning model can be trained with images of objects associated with descriptions and real-world measurements. As such, the measurement classification can be associated with estimated measurements of objects. For example, a narrow width of a user's face, a tall height of a user's body, and a medium width of a glasses frame can each be associated with particular real-world measurement values, which can be used as the estimated measurements of objects.

In step 708, the first measurement of the object is compared to the estimated measurement of the object to determine a scaling ratio. As an example, if a measurement classification associated with an object is a medium male face width, the estimated measurement can be about 14 cm. The estimated measurement (e.g., 14 cm for a medium male face width) can be compared to (e.g., divided by) the determined first measurement of the object (e.g., a measured/determine width of the user's face), thus determining the scaling ratio. Step 708 can be similar to or the same as step 108 of method 100, discussed above with respect to FIG. 1.

In step 710, the 3D model is scaled based on the scaling ratio. The 3D model can be scaled using the scaling ratio by multiplying the 3D model of step 702 by the scaling ratio. As a result, the first measurement of the object in the scaled 3D model can correspond to or otherwise match the estimated measurement of the object. In some examples, the scaled 3D model can be used to present 3D models of various products over the object in virtual try-ons or the like. The scaled 3D model can be of a product that can be presented over other 3D models of objects in virtual try-ons or the like. In some examples, measurements of the object can be determined from the scaled 3D model, which can be used for sizing or ordering various products. Step 710 can be similar to or the same as step 110 of method 100, discussed above with respect to FIG. 1.

The facial features can include any facial features that can be used to scale the 3D model to real-world dimensions. The facial features can include positions of facial features, sizes of facial features, and the like. In some examples, the facial features can include positions and/or sizes of the user's irises, which can be marked by an iris contour applied to the images and/or the 3D model. In some examples, the facial features can include positions of the user's temples, ear junctions, pupils, eyebrows, eye corners, a nose point, a nose bridge, cheekbones, and the like. In examples in which the facial features include positions of the user's temples or ear junctions, the facial features can include a face width of the user's face. In examples in which the facial features include positions of the user's pupils, the facial features can include a pupil distance of the user's face. As will be discussed in detail below, diameters of the user's irises, the user's face width, and/or the user's pupillary distance can be used to scale the 3D model to real-world dimensions.

Although the foregoing examples have been described in some detail for purposes of clarity of understanding, the invention is not limited to the details provided. There are many alternative ways of implementing the invention. The disclosed examples are illustrative and not restrictive.

What is claimed is:

1. A system, comprising:
a processor; and
a memory coupled to the processor and configured to provide the processor with instructions, which instructions, when executed by the processor, cause the processor to:
obtain a set of images of a user's head;
generate a model of the user's head based on the set of images;
determine a scaling ratio based on the model of the user's head and estimated facial features; and
apply the scaling ratio to the model of the user's head to obtain a scaled user's head model.

2. The system of claim 1, wherein the estimated facial features comprise historical facial features, and wherein determining the scaling ratio comprises:
determining a measured facial feature from an image of the set of images;
updating the model of the user's head based on the measured facial feature; and
determining the scaling information based on the measured facial feature and at least a portion of the estimated facial features.

3. The system of claim 1, wherein determining the scaling ratio comprises:
determining a head width classification corresponding to the user's head using a machine learning model based on the set of images;
obtaining a set of proportions corresponding to the head width classification, wherein the estimated facial features comprise the set of proportions;
determining a measured facial feature from the model of the user's head; and
determining the scaling ratio based on the measured facial feature and the estimated facial features.

4. The system of claim 1, wherein the processor is further configured to:
position a glasses frame model on the scaled user's head model; and
determine a set of facial measurements associated with the user's head based on stored measurement information associated with the glasses frame model and the position of the glasses frame model on the scaled user's head model.

5. The system of claim 4, wherein the processor is further configured to determine a confidence level corresponding to a facial measurement of the set of facial measurements.

6. The system of claim 4, wherein the processor is further configured to:
compare the set of facial measurements to stored dimensions of a set of glasses frames; and
output a recommended glasses frame at a user interface based at least in part on the comparison.

7. The system of claim 4, wherein the processor is further configured to:
input the set of facial measurements into a machine learning model to obtain a set of recommended glasses frames; and
output the set of recommended glasses frames at a user interface.

8. A method for generating a three-dimensional (3D) model, comprising:
receiving a set of images of an object;
generating an initial model of the object based on the set of images;
determining a first measurement of a first feature of the object;
classifying the object with a measurement classification, wherein the measurement classification is associated with an estimated measurement of the first feature;
determining a scaling ratio for the initial model based on the first measurement and the estimated measurement; and
scaling the initial model to generate a scaled model based on the scaling ratio.

9. The method of claim 8, wherein:
the object comprises a user's head; and
the first feature comprises a face width.

10. The method of claim 9, wherein the measurement classification is selected from a list comprising narrow, medium, and wide.

11. The method of claim 8, further comprising:
positioning a 3D model on the scaled model, wherein the 3D model is associated with real-world dimensions; and
generating measurements of the object based on the position of the 3D model on the scaled model and a comparison of the 3D model with the scaled model.

12. The method of claim 8, further comprising determining measurements of the object based on the scaled model.

13. The method of claim 12, further comprising determining a confidence level corresponding to each measurement of the measurements.

14. The method of claim 8, further comprising:
receiving a second set of images, wherein each image of the second set of images comprises a learning object including a learning feature associated with a second measurement and a respective measurement classification; and
analyzing the second set of images with a machine learning model to associate each respective measurement classification of a set of measurement classifications with a respective second measurement, wherein the measurement classification is selected from the set of measurement classification to classify the object.

15. A computer program product, the computer program product being embodied in a non-transitory computer readable storage medium and comprising computer instructions for:
receiving a set of images of a user's head;
generating an initial three-dimensional (3D) model of the user's head based on the set of images;
analyzing the set of images to detect a facial feature on the user's head;
comparing the detected facial feature with an estimated facial feature to determine a scaling ratio, wherein the estimated facial feature comprises at least one of an iris diameter, an ear junction distance, or a temple distance; and
scaling the initial 3D model to generate a scaled 3D model based on the scaling ratio.

16. The computer product of claim 15, wherein:
the estimated facial feature comprises an average measurement of a facial feature in a population; and
the computer instructions further comprise determining the estimated facial feature.

17. The computer product of claim 15, wherein:
the estimated facial feature comprises the iris diameter; and
the iris diameter is from 11 mm to 13 mm.

18. The computer product of claim 15, wherein the computer instructions further comprise:
positioning a 3D model of a glasses frame on the scaled 3D model; and
determining facial measurements of the user based on measurements associated with the 3D model of the glasses frame and the position of the glasses frame on the scaled 3D model.

19. The computer product of claim 15, wherein the computer instructions further comprise:
determining a head width classification of the user's head; and
determining the estimated facial feature based on the head width classification of the user's head.

20. The computer product of claim 19, wherein the computer instructions further comprise associating head width classifications of a set of head width classifications with respective estimated facial features of a set of estimated facial features using a machine learning model that comprises an input of a set of images, wherein each image of the set of images comprises a head width classification and a facial feature measurement.
